(19) United States
(12) Patent Application Publication
(10) Pub. No.: US 2003/0170163 A1
(43) Pub. Date: Sep. 11, 2003

(54) Synthethic process of manufacturing micronised pure magnetic grade ferric oxide Fe2O3

(76) Inventors: Pritish Chandra Banerjee, Beaverton, OR (US); Ashis Chatterjee, Beaverton, OR (US)

Correspondence Address: ASHIS CHATTERJEE, 4118 NW SCOTTSDALE DRIVE, BEAVERTON, OR, 97006, US

(21) Appl. No.: 10/091,972

(22) Filed: Mar. 7, 2002

(51) Int. Cl. C01G 49/00

(52) U.S. Cl. 423/395

(57) ABSTRACT

Pure Ferric Oxide is used to produce Ferrite for electronic industries. It is also known as an important pigment in the name of Red oxide.

Synthetic pure Ferric Oxide is generally manufactured by chemical reaction with iron scrap and inorganic acid like Sulfuric or Hydrochloric Acid and other processes for manufacturing Ferric Oxide are also known, but Nitric acid is not used to manufacture Ferric Oxide due to passivation problem with iron scraps. The passivation problem is responsible for very slow speed reaction with Nitric acid and iron and it ultimately stops.

This invention is a process to avoid passivation problem and to create tremendously vigorous chemical reaction with Nitric acid and iron scrap. With the help of oxygen, heating process and application of small pressure, the speed of the chemical reaction suddenly become vigorous when iron turns into hydrated Ferric Oxide Fe₂O₃.H₂O dispersion in acid-water media. Acidity of the dispersion is reduced by passing through series of similar reactors packed with iron scraps under same condition of that reactor.

The resultant product is followed by mechanical purification and after that sent to spray drying roaster to get 98% pure Ferric Oxide Fe₂O₃ of micron size. The exit gases mainly Nitrogen Dioxide (NO₂) can be sent to Nitric acid plant for reuse in the reaction or NO₂ can be absorbed in suitable chemical absorbent to get its nitrate.

This Ferric Oxide is magnetic grade and thus suitable for the production of Ferrite in electronic industries. This is also a pigment in the name of Red Oxide.

### BACKGROUND OF THE INVENTION

Pure Ferric Oxide is used to produce Ferrite for electronic industries. It is also known as an important pigment in the name of Red oxide.

Synthetic pure Ferric Oxide is generally manufactured by chemical reaction with iron scrap and inorganic acid like Sulfuric or Hydrochloric Acid and other processes for manufacturing Ferric Oxide are also known, but Nitric acid is not used to manufacture Ferric Oxide due to passivation problem with iron scraps. The passivation problem is responsible for very slow speed reaction with Nitric acid and iron and it ultimately stops.

This invention is a process to avoid passivation problem and to create tremendously vigorous chemical reaction with Nitric acid and iron scrap.

### DESCRIPTION OF THE PRIOR ART

Pure Ferric Oxide is used to produce Ferrite for electronic industries. It is also known as an important pigment in the name of Red oxide.

Synthetic pure Ferric Oxide is generally manufactured by chemical reaction with iron scrap and inorganic acid like Sulfuric or Hydrochloric Acid and other processes for manufacturing Ferric Oxide are also known, but Nitric acid is not used to manufacture Ferric Oxide due to passivation problem with iron scraps.

### SUMMARY OF THE INVENTION

Pure Ferric Oxide is used to produce Ferrite for electronic industries. It is also known as an important pigment in the name of Red oxide.

Synthetic pure Ferric Oxide is generally manufactured by chemical reaction with iron scrap and inorganic acid like Sulfuric or Hydrochloric Acid and other processes for manufacturing Ferric Oxide are also known, but Nitric acid is not used to manufacture Ferric Oxide due to passivation problem with iron scraps. The passivation problem is responsible for very slow speed reaction with Nitric acid and iron and it ultimately stops.

This invention is a process to avoid passivation problem and to create tremendously vigorous chemical reaction with Nitric acid and iron scrap. With the help of oxygen, heating process and application of small pressure, the speed of the chemical reaction suddenly become vigorous when iron turns into hydrated Ferric Oxide Fe₂O₃.H₂O dispersion in acid-water media. Acidity of the dispersion is reduced by passing through series of similar reactors packed with iron scraps under same condition of that reactor.

The resultant product is followed by mechanical purification and after that sent to spray drying roaster to get 98% pure Ferric Oxide Fe₂O₃ of micron size. The exit gases mainly Nitrogen Dioxide (NO₂) can be sent to Nitric acid plant for reuse in the reaction or NO₂ can be absorbed in suitable chemical absorbent to get its nitrate.

This Ferric Oxide is magnetic grade and thus suitable for the production of Ferrite in electronic industries. This is also a pigment in the name of Red Oxide.

### BRIEF DESCRIPTION OF THE DRAWING

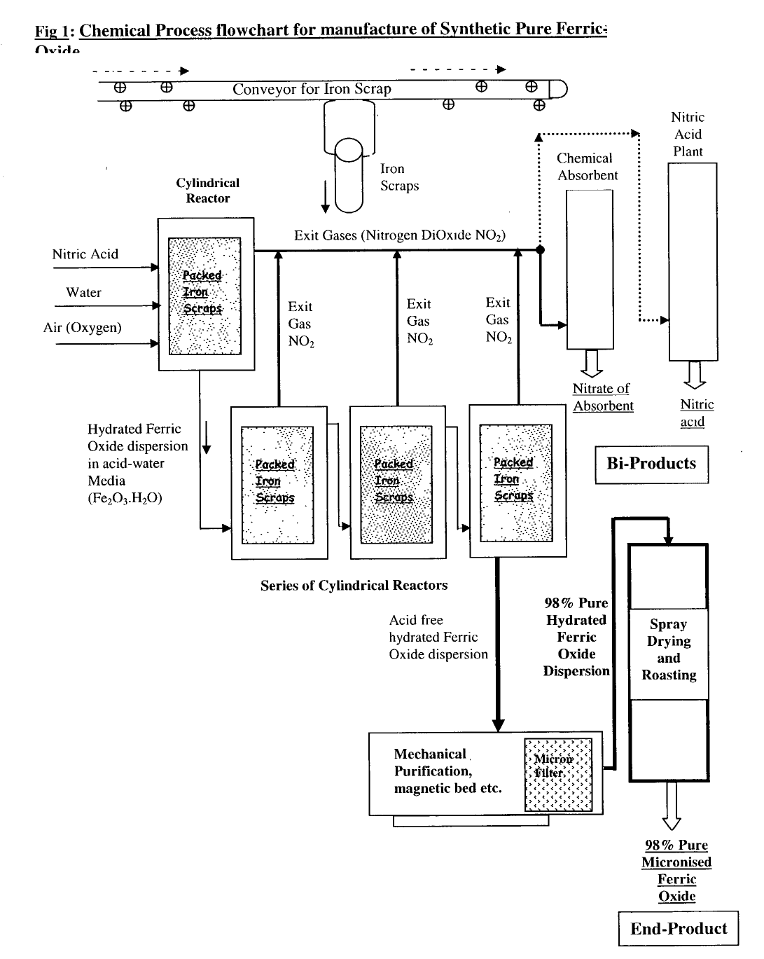

The drawing in FIG. 1 illustrates the Chemical Process Flowchart for Manufacture of Synthetic Pure Ferric Oxide. The flowchart is described below:

The flow-chart in FIG. 1 shows a large cylindrical reactor having oval shape at the top and bottom with opening in the central part of the oval surfaces. Through the conveyer belt (shown on the top) iron scraps enter into a cylindrical capsule in which top and bottom doors are automatically closed or opened. At the time of feeding iron scraps into the reactor the bottom of cylindrical capsule gets fixed at the top of reactor and the door of the capsule opens automatically. At the same time, the top door of the reactor also opens up and the iron scraps, driven by gravity, falls downwards into the movable cylindrical wire cage, inside the reactor.

As explained above, the surface of iron scraps must be cleared from the product, which is hydrated Ferric Oxide viscous dispersion for the continuation of vigorous reaction. The cylindrical wire-cage, packed with Iron scraps, moves in the acid-water fluid for surface washing of iron scraps. The surface washed iron scraps continues the vigorous reaction.

There are three inlet tubes fixed in the reactor for passing

(a) concentrated Nitric acid

(b) Water, and

(c) Air (Oxygen) blown from compressor.

All these tubes have arrangements to heat the passing materials with controlled temperature. The reactor has wide tube at the bottom to discharge the product hydrated ferric oxide dispersion. The other end of the wide tube is connected with a similarly constructed reactor. This reactor has an opening in the side-wall at a certain height from where a wide tube is connected with another similar reactor. The dispersion product overflows to another reactor by that wide tube.

In this way dispersion product overflows from one reactor to another reactor and interacts with iron scraps until and unless the acidity of the dispersion reduces to a great extent and becomes suitable for spray drying and roasting. Series of reactors are installed to reduce acidity of the dispersion. The construction of all reactors, in the series are similar.

The dispersion product is mechanically purified by passing through magnetic bed to remove iron particles, dust etc. This finally gets purified by passing through micron filters.

Ultimately, hydrated Ferric Oxide dispersion enters into spray drying and roasting plant unit, to get micronised particles of 98% pure ferric oxide.

The exit gases, Nitrogen Di-oxide (NO₂) is passed through suitable commercial chemical absorbent to get the corresponding Nitrate of the absorbent, which can be commercially important.

Another option is to send the exit gases, Nitrogen Di-oxide (NO₂) into the Nitric Acid plant to reuse nitric acid.

### DETAILED DESCRIPTION OF THE INVENTION

Pure Ferric Oxide is used to produce Ferrite for electronic industries. It is also known as an important pigment in the name of Red oxide.

Synthetic pure Ferric Oxide is generally manufactured by chemical reaction with iron scrap and inorganic acid like Sulfuric or Hydrochloric Acid and other processes for manufacturing Ferric Oxide are also known, but Nitric acid is not used to manufacture Ferric Oxide due to passivation problem with iron scraps. The passivation problem is responsible for very slow speed reaction with Nitric acid and iron and it ultimately stops.

This invention is a process to avoid passivation problem and to create tremendously vigorous chemical reaction with Nitric acid and iron scrap. With the help of oxygen, heating process and application of small pressure, the speed of the chemical reaction suddenly become vigorous when iron turns into hydrated Ferric Oxide Fe₂O₃.H₂O dispersion in acid-water media. Acidity of the dispersion is reduced by passing through series of similar reactors packed with iron scraps under same condition of that reactor.

The resultant product is followed by mechanical purification and after that sent to spray drying roaster to get 98% pure Ferric Oxide Fe₂O₃ of micron size. The exit gases mainly Nitrogen Dioxide (NO₂) can be sent to Nitric acid plant for reuse in the reaction or NO₂ can be absorbed in suitable chemical absorbent to get its nitrate.

This Ferric Oxide is magnetic grade and thus suitable for the production of Ferrite in electronic industries. This is also a pigment in the name of Red Oxide.

This is a process to create tremendously vigorous chemical reaction with Nitric Acid and iron scrap, even though it is known that the chemical reaction with Nitric acid and iron is very slow and ultimately stops due to passivation problems.

During the vigorous reaction the resultant product is micronised hydrated Ferric Oxide Fe₂O₃.H₂O dispersion in acidic water media and Oxides of Nitrogen gases are evolved. The reactants are Nitric acid, Iron scraps, Water and Air (oxygen).

Heating process is regulated to get a temperature to attain vigorous reaction and some small pressure is also applied. As the reaction is exothermic, the temperature is properly controlled so that the product will be hydrated Ferric Oxide Fe₂O₃.H₂O dispersion and not Ferric Nitrate solution. The brownish yellow color of the dispersion gets a darker shade at higher temperature and that is to be avoided. It is important to ensure that the temperature does not fall below suitable limits.

Chemical purification is not required to get 98% pure Ferric Oxide. However, mechanical purification is required to remove iron and dust particles of iron scrap though the scraps are thoroughly washed before feeding into the reactor. The Hydrated Ferric Oxide Fe₂O₃.H₂O dispersion product from the reactor is passed through series of similar reactors that maintain similar conditions so as to get negligible acidity in the dispersion product. After that, the dispersion product are passed through magnetic beds to remove iron particles, dust and refined by mechanical purification and finally by micron filter.

By-products like organic or inorganic nitrates can be produced by absorbing the exit gases containing Oxides of Nitrogen, Air (oxygen), water vapor or steam in suitable absorbent according to commercial demand. If necessary, the exit gases mainly Oxides of Nitrogen can be sent to nitric acid plant for reuse in above reaction.

Magnetic grade of Ferric Oxide Fe₂O₃ of 98% purity can be manufactured by a chemical reaction with Nitric acid (water for dilution) and iron scraps in presence of Oxygen from air blow. It is important to note that catalysts are not used in this reaction.

During the vigorous reaction, high viscous dispersion product is produced in the mixture of water and acid media. This viscous dispersion layer of Fe₂O₃.H₂O covers the surface of iron scraps and thus Nitric Acid gets resistance to reach the surface of iron. As a result, the speed of the chemical reaction reduces.

To overcome this problem, dispersion layer on the surface of iron scraps must be cleared by moving iron scraps in acid-water mixture. A turbulent motion is also created by air blow, to remove dispersion layer from iron surface. It is to be noted that the evolved Oxides of Nitrogen gases also helps to maintain the speed of the chemical reaction, and keep it vigorous.

Construction of the Plant Unit:

The mechanical construction of the Plant Unit in-order to achieve the vigorous chemical reaction, as described above is as follows:

The preferred material for the construction of the plant is Stainless steel, or other such non-corrosive material. A big cylindrical cage, made of thick wire net and having an opening gap of suitable size, is constructed. This must be strongly built to carry necessary quantity of iron scrap of various sizes. The cylindrical cage is inserted into the cylindrical reactor whose internal diameter is considerably larger than the external diameter of the cylindrical wire cage so that it can rotate freely, inside the reactor. The cylindrical cage is completely dipped into the reactant fluid of acid-water mixture and when it rotates, a turbulent motion is developed in the fluid. During the chemical reaction, Nitric acid, water and air blow produces Fe₂O₃.H₂O and gaseous Oxides of Nitrogen. This makes the motion more turbulent and creates conditions for the continuation of vigorous reaction.

The Reactants:

The reactants are the following:

(a) Concentrated Nitric acid (25%-60%)

(b) Iron scraps

(c) Air blow from a compressor

(d) Boiling Water

Note that Catalyst is not required.

The Resultant Product of the Reactants:

The following are the resultant products from the reaction.

(a) High viscous Hydrated Ferric Oxide Fe₂O₃.H₂O dispersion in acid-water media

which ultimately produces Ferric Oxide.

(b) Product gases mainly Oxides of Nitrogen.

Complete utilization of nitric acid by reacting with iron scraps is necessary because the dispersion of Hydrated Ferric Oxide Fe₂O₃.H₂O must be almost acid free before spray drying and roasting. If the dispersion contains some acid, then during the heating, fumes of Nitric acid will evolve and these fumes are not good for the spray drying process. To rectify the acidic problem, the product from the first reactor is passed through a number of similar reactors packed with iron scraps until the last traces of acid is utilized for iron.

The dispersion Fe₂O₃.H₂O, contains iron particles and also dust coming from iron scraps and thus dispersion product is passed through a magnetic bed to separate iron particles by attraction process. This is further purified by mechanical process and finally by Micron Filter to get 98% pure hydrated Ferric Oxide Fe₂O₃.H₂O dispersion. It is diluted to specific concentration around 20% or 25% which will be suitable for perfect flow property to run into spray drying and roasting plant to get Ferric Oxide of 98% purity in micron particle.

The Product gases (derived from the reactants) are mainly Oxides of Nitrogen (NO2 maximum) and it is to be absorbed in such an absorbent so that its nitrate type product must be commercially demanded.

The exit gases contain also excess Oxygen from air blow, water vapor or steam, and thus the entire exit gases can be sent to Nitric acid plant to reuse Nitric acid for the chemical reaction with iron scraps. Ultimately, the only consumption in the entire production process, will be iron scraps for the production of magnetic grade ferric-oxide Fe₂O₃ of 98% purity.

The Reactor Plant Unit:

The material for the construction of the reactor is stainless steel, or other suitable non-corrosive material.

A large cylindrical reactor having oval shape at the top and bottom with opening in the central part of the oval surfaces. Through the conveyer belt (shown on the top) iron scraps enter into a cylindrical capsule in which top and bottom doors are automatically closed or opened. At the time of feeding iron scraps into the reactor the bottom of cylindrical capsule gets fixed at the top of reactor and the door of the capsule opens automatically. At the same time, the top door of the reactor also opens up and the iron scraps, driven by gravity, falls downwards into the movable cylindrical wire cage, inside the reactor.

As explained above, the surface of iron scraps must be cleared from the product, which is hydrated Ferric Oxide viscous dispersion for the continuation of vigorous reaction. The cylindrical wire cage, packed with Iron scraps, moves in the acid-water fluid for surface washing of iron scraps. The surface washed iron scraps continues the vigorous reaction.

There are three inlet tubes fixed in the reactor for passing

(a) concentrated Nitric acid approx. 25%-60% concentration

(b) Water, and

(c) Air (Oxygen) blown from compressor.

All these tubes have arrangements to heat the passing materials with controlled temperature. The reactor has wide tube at the bottom to discharge the product hydrated ferric oxide dispersion. The other end of the wide tube is connected with a similarly constructed reactor. This reactor has an opening in the side-wall at a certain height from where a wide tube is connected with another similar reactor. The dispersion product overflows to another reactor by that wide tube.

In this way dispersion product overflows from one reactor to another reactor and interacts with iron scraps until and unless the acidity of the dispersion reduces to a great extent and becomes suitable for spray drying and roasting. Series of reactors are installed to reduce acidity of the dispersion. The construction of all reactors, in the series are similar.

The dispersion product is mechanically purified by passing through magnetic bed to remove iron particles, dust etc. This finally gets purified by passing through micron filters.

Ultimately, hydrated Ferric Oxide dispersion enters into spray drying and roasting plant unit, to get micronised particles of 98% pure ferric oxide.

The exit gases, Nitrogen Di-oxide (NO₂) is passed through suitable commercial chemical absorbent to get the corresponding Nitrate of the absorbent, which can be commercially important.

Another option is to send the exit gases, Nitrogen Di-oxide (NO₂) into the Nitric Acid plant to reuse nitric acid.

Chemical Reaction:

When hot water, concentrated Nitric Acid, and air blow interact with iron scraps inside a reacting vessel under small pressure at a temperature around suitable temperature, then suddenly vigorous exothermic reactions occur and iron scraps turns into micronised dispersion of hydrated Ferric Oxide Fe₂O₃.H₂O in water-acid media. To reduce the acidity of the dispersion, the resultant product is passed through series of reactors containing iron scraps that maintains similar conditions for chemical reaction so as to maintain the maximum speed of the reaction. This ultimately utilizes the last traces of acid for the conversion of iron scraps. Depending on the quality of iron scraps some of iron turns into dust particle and thus most of the iron is consumed.

The exit gases are mainly Oxides of Nitrogen which can be absorbed in suitable organic or inorganic absorbent so that its by-product have commercial demand. As the exit gases also contain air (Oxygen), water vapor or steam, the entire exit gases can be sent to Nitric acid plant for reuse in above reaction. Therefore iron scraps will be the mainly consumed material for the production of Ferric Oxide Fe₂O₃. Hydrated Ferric Oxide dispersion is mechanically refined and sent for spray drying and roasting to get 98% pure magnetic Ferric oxide.

| | | | | | | | | |
|---|---|---|---|---|---|---|---|---|
| 2 Fe | + | 2HNO₃ | + | O₂ | → | Fe₂O₃.H₂O | + | 2NO₂ |
| iron | | nitric acid | | oxygen | | hydrated | | nitrogen dioxide |
| scraps | | with | | from | | ferric oxide | | (oxides of nitrogen) |
| | | additional | | air | | dispersion in | | |
| | | water | | | | acid-water media | | |

| | | |
|---|---|---|
| Fe₂O₃.H₂O | → | Fe₂O₃ |
| Mechanically | | magnetic grade ferric oxide |
| Purified, spray dried | | 98% pure |
| and roasted | | |

NO₂ and exit gases + chemical absorbent → nitrate of absorbent

or

NO₂ and exit gases → to nitric acid plant → HNO₃ for reuse

The sedimentation of high viscous micronised Fe₂O₃.H₂O particles are very slow. Thus process of interaction with fresh water will not at all help to reduce the acidity of the dispersion.

Due to passivation problem iron, surface must be cleared from Fe₂O₃.H₂O dispersion layer.

Iron particles of the dispersion are removed by magnetic filter and ultimately purified by passing through micron filter to get 98% pure hydrated Ferric Oxide Fe₂O₃.H₂O dispersion for which chemical refining is not required.

Viscosity of the dispersion can be reduced by adding water so that the dispersion is suitable for spray drying subject to design of the spray drying and roasting plant.

The internal construction of the reactor is such that viscous layer of the dispersion must not form deposit on any surface of the internal parts of the reactor because that deposit will form a hard coating on that surface. For example heating source or heating element must be free from the formation of such hard coating as it will be a problem for heat economy.

1. We claim that this invention is a process to create tremendously vigorous chemical reaction with Nitric Acid and iron scrap even though it is known that the chemical reaction with Nitric acid and iron is very slow and ultimately stops due to passivation problem.

2. We claim that during the vigorous reaction, the resultant product is micronised high-purity magnetic grade hydrated Ferric Oxide Fe₂O₃.H₂O dispersion in acidic water media and Oxides of Nitrogen gases evolve. The reactants are Nitric acid, Iron scraps, Water and Air (oxygen).

3. We claim that the heating process of the chemical reaction is regulated to get a temperature to attain vigorous reaction and some small pressure is also applied. As the reaction is exothermic, the temperature is properly controlled so that the product will be hydrated Ferric Oxide Fe₂O₃.H₂O dispersion and not Ferric Nitrate solution. The brownish yellow color of the dispersion gets darker shade at higher temperature and that is to be avoided. At the same time, the temperature should be controlled to not fall below the suitable level.

4. We claim that chemical purification is not required to get 98% pure Ferric Oxide. However, mechanical purification is required to remove iron and dust particles of iron scrap, and finally a micron filter is used, though the scraps are thoroughly washed before feeding into the reactor. The Hydrated Ferric Oxide Fe₂O₃.H₂O dispersion product from the reactor is passed through series of similar reactors that maintains similar conditions so as to get negligible acidity in the dispersion product.

5. We claim that By-products like organic or inorganic nitrates can be produced by absorbing the exit gases containing Oxides of Nitrogen, Air (oxygen), water vapor or steam in suitable absorbent according to commercial demand. If necessary, the exit gases mainly Oxides of Nitrogen can be sent to nitric acid plant for reuse in above reaction.
